(19) United States
(12) Patent Application Publication
(10) Pub. No.: US 2025/0158218 A1
(43) Pub. Date: May 15, 2025

(54) Battery System Rack and Method for Accommodating at Least One First and at Least One Adjacent Second Battery Module in a Battery System

(71) Applicant: Siemens Mobility GmbH, München, Bayern (DE)

(72) Inventors: Maik Dittrich, Erlangen, Bayern (DE); Tim Weigel, München (DE); Matthias Commes, Gauting (DE)

(73) Assignee: Siemens Mobility GmbH, München, Bayern (DE)

(21) Appl. No.: 18/839,661

(22) PCT Filed: Jan. 31, 2023
(86) PCT No.: PCT/EP2023/052271

§ 371 Date: Aug. 19, 2024

(30) Foreign Application Priority Data
Feb. 25, 2022 (DE) 10 2022 201 950.4

(51) Int. Cl. H01M 50/383; B61C 17/06; H01M 10/6551; H01M 50/204; H01M 50/249; H01M 50/258; H01M 50/342

(52) U.S. Cl. CPC H01M 50/383; B61C 17/06; H01M 10/6551; H01M 50/204; H01M 50/249; H01M 50/258; H01M 50/3425; H01M 2220/20

(57) ABSTRACT

The teachings herein include battery systems for a vehicle. An example system includes: a first battery module and a second battery module each formed from a respective plurality of battery cells. The first battery module is arranged in a separate tube of a fire-resistant material having an opening formed in its side to provide pressure relief. The tube comprises a fire-resistant interface for operation of the first battery module. A pressure relief device and a fire-resistant exhaust air device are arranged at the opening mounted so gases emitted by the pressure relief means can be discharged in a controlled manner and conveyed through the exhaust air device.

### CROSS-REFERENCE TO RELATED APPLICATIONS

This application is a U.S. National Stage Application of International Application No. PCT/EP2023/052271 filed Jan. 31, 2023, which designates the United States of America, and claims priority to DE Application No. 10 2022 201 950.4 filed Feb. 25, 2022, the contents of which are hereby incorporated by reference in their entirety.

### TECHNICAL FIELD

The present disclosure relates to electric batteries. Various embodiments of the teachings herein include a battery system rack for accommodating at least one first and at least one adjacent second battery module in a vehicle in order to form a battery system.

### BACKGROUND

Battery systems based on lithium-ion battery cells are known. For example, such systems are also used in rail vehicles for the traction related and electrical system applications thereof. A typical lithium-ion battery system for traction-related and electrical system applications, in particular for the definition of safety requirements, can be schematically illustrated here as depicted in FIG. 1.

Accordingly, in the case of a battery system used for this purpose, it is possible to distinguish three levels here. A first level E1 is formed here by one battery cell. A number of such cells in turn form a battery module. This can be regarded as the second level E2. The battery system and thus ultimately the third level E3 is generally formed by a plurality of battery modules.

Lithium-ion battery cells fundamentally have the risk of catching fire as a result of an internal short circuit. This reaction is strongly exothermic and is referred to as so-called thermal runaway (TRA). During such a reaction, a large amount of the electrically stored energy is converted into heat. Causes of the internal short circuit can, for example, be faults in the production of the cell, such as foreign particles.

A TRA—provided it was not triggered, for example, by human error—is an event in a cell which is therefore generally random and may spontaneously occur at any time, both during operation and during storage. The causes of a TRA are set down here in the cells as early as manufacture, for example. A TRA thus cannot be ruled out or prevented, and therefore, in particular in the case of such large systems as are used in rail vehicles, a safety concept ensuring traffic safety is necessary.

In order to prove the safety of the battery system, the EN 62619 standard therefore requires what is referred to as the thermal propagation test (TPT). In this case, it has to be demonstrated that, after an individual cell internally short-circuits, no fire occurs either at cell level (first level E1), module level (second level E2) or battery system level (third level E3). Known concepts ensuring this consist, for example, in a TRA-resistant container for the entire battery system. This solution is, however, expensive, not least because the container is provided with a heavy outer housing.

A further approach is to use safer cells. That is to say to use lithium-ion cells which are constructed such that they have reduced TRA energy and/or which are equipped with protective mechanisms that are internal to the cells. This approach also results in high costs.

Another concept is to provide fire-retardant barriers, for example phase-change materials, between individual cells within a module. However, this concept is not convincing in terms of the reliability of its function, whereas in which approach of permanently providing an active supply of cooling water into the system by means of electrically operated water pumps in order to cool the system has a high degree of reliability during operation in the vehicle using it. A disadvantage of this, however, is that this function certainly cannot be ensured while the vehicle is shut down.

### SUMMARY

The teachings of the present disclosure include solutions which make it possible to use lithium ion cells in vehicles, e.g., in rail vehicles, substantially without restricting the configuration of the cells. For example, some embodiments of the teachings herein include a battery system rack for accommodating at least one first and at least one second battery module (BM) in a vehicle in order to form a battery system, e.g. in an engine compartment of the vehicle, in particular of a rail vehicle, characterized in that a) the first battery module and second battery module (BM) are formed from a plurality of, in particular lithium ion, battery cells, b) at least the first battery module is arranged in a separate tube (R_{1 . . . n}), which is in particular formed rectangularly from four individual side parts, c) the tube (R_{1 . . . n}) is formed from a fire-resistant material, d) the tube (R_{1 . . . n}) has an opening (L), which is formed in a tube side, for providing pressure relief, e) the tube (R_{1 . . . n}) comprises a fire-resistant interface for the connection and operation of the battery module (BM) in the battery system (BS), f) the tube (R_{1 . . . n}) is designed such that, at every opening (L), a pressure relief means and a fire-resistant exhaust air device (AK), in particular a chimney, is mounted such that gases emitted by the pressure relief means can be discharged in a controlled manner so as to be conveyed through the exhaust air device (AK), g) the tube (R_{1 . . . n}), the interface and/or the pressure relief means is designed and/or arranged in such a manner that the battery module (BM) is at least temporarily hermetically sealed by the tube (R_{1 . . . n}), the interface and the pressure relief means, h) two sheet metal frames (BR) are designed such that, at front and back ends, in order to accommodate the tubes (R_{1 . . . n}), they have cutouts formed according to the tube cross section, the edges of which cutouts are connected to the tubes R_{1 . . . n}, i) the sheet metal frames (BR) for accommodating the battery modules (BM) are designed in such a manner that, between a tube (R_{1 . . . n}) of a battery module (BM) and adjoining surfaces, which are in particular connected to adjacent battery modules (BM) by heat transfer, a multiplicity of air gaps (LS) are formed in such a manner, and are connected and designed in such a manner, that they form a structure which dissipates heat emitted by the battery module (BM) in a controlled manner by a chimney effect, wherein the cutouts and openings (L) are arranged in such a manner that the exhaust air device (AK), in particular between two tubes (R_{1 . . . n}), is connected to said tubes, j) the sheet metal frames for mounting the battery system are designed to be connectable at least temporarily to a base frame (GR), k) a first closure is mounted at the front end of each of the tubes (R_{1 . . . n}) and a second closure is mounted at the back end of each of the tubes (R_{1 . . . n}) so as to be tight with respect to gases produced inside the tubes R_{1 . . . n}, and 1) at least the tube (R_{1 . . . n}) is connected to the sheet metal frames (BR) and/or the exhaust air device (AK) at least partially based on welding.

In some embodiments, at least one reinforcement rib which at least partially surrounds the cross section of the tube (R_{1 . . . n}) is welded onto the tube (R_{1 . . . n}).

In some embodiments, the thermal insulation is formed from a bidirectionally insulating material.

In some embodiments, the pressure relief means is in the form of a rupture membrane connected in the opening of the tube (R_{1 . . . n}) to the tube (R_{1 . . . n}), the exhaust air device (AK) and/or the thermal insulation.

In some embodiments, the pressure relief means is in the form of a rupture disk.

In some embodiments, the pressure relief means is in the form of at least one spring-loaded pressure relief flap.

In some embodiments, the tube (R_{1 . . . n}), the reinforcement ribs, the metal sheets and/or the exhaust air device (AK) are formed from stainless steel.

In some embodiments, in order to seal the first and/or second closure (D), a sealing surface (DF) is in each case provided between closures (D) and tubes (R_{1 . . . n}).

In some embodiments, for sealing purposes, the second closures (D) are each welded to the back side of the tubes (R_{1 . . . n}) and/or to the edges of the cutouts of the sheet metal frame (BR).

As another example, some embodiments include a method for accommodating at least one first and at least one second battery module (BM) in a vehicle in order to form a battery system (BS), preferably in an engine compartment of the vehicle, in particular of a rail vehicle, characterized in that a) the first battery module and second battery module (BM) are formed from a plurality of, in particular lithium ion, battery cells, and operated, b) at least the first battery module is arranged in a separate tube (R_{1 . . . n}), which is in particular formed rectangularly from four individual side parts, and operated, c) the tube (R_{1 . . . n}) is formed from a fire-resistant material, and operated, d) the tube (R_{1 . . . n}) comprises an opening (L), which is formed in a tube side, for providing pressure relief, e) the tube (R_{1 . . . n}) comprises a fire-resistant interface for the connection and operation of the battery module (BM) in the battery system (BS), f) the tube (R_{1 . . . n}) is designed and operated such that, at every opening (L), a pressure relief means and a fire-resistant exhaust air device (AK), in particular a chimney, is mounted such that gases emitted by the pressure relief means can be discharged in a controlled manner so as to be conveyed through the exhaust air device (AK), g) the tube (R_{1 . . . n}), the interface and/or the pressure relief means is designed and/or arranged and operated in such a manner that the battery module (BM) is at least temporarily hermetically sealed by the tube (R_{1 . . . n}), the interface and the pressure relief means, h) two sheet metal frames (BR) are designed and operated such that, at front and back ends, in order to accommodate the tubes (R_{1 . . . n}), they have cutouts formed according to the tube cross section, the edges of which cutouts are connected to the tubes R_{1 . . . n}, i) the sheet metal frames (BR) for accommodating the battery modules (BM) are designed and operated in such a manner that, between a tube (R_{1 . . . n}) of a battery module (BM) and adjoining surfaces, which are in particular connected to adjacent battery modules (BM) by heat transfer, a multiplicity of air gaps (LS) are formed in such a manner, and are connected and designed and operated in such a manner, that they form a structure which dissipates heat emitted by the battery module (BM) in a controlled manner by a chimney effect, wherein the cutouts and openings (L) are arranged and operated in such a manner that the exhaust air device (AK), in particular between two tubes (R_{1 . . . n}), is operated connected to said tubes, j) the sheet metal frames (BR) for mounting the battery system are designed to be connectable at least temporarily to a base frame (GR), and operated, k) a first closure is mounted at the front end of each of the tubes (R_{1 . . . n}) and a second closure is mounted at the back end of each of the tubes (R_{1 . . . n}) so as to be tightly operated with respect to gases produced inside the tubes R_{1 . . . n}, and 1) at least the tube (R_{1 . . . n}) is connected to the sheet metal frames (BR) and/or the exhaust air device (AK) at least partially based on welding.

### BRIEF DESCRIPTION OF THE DRAWINGS

Further advantages and details of the teachings are explained on the basis of the prior art illustrated in FIG. 1 with reference to the views of an exemplary embodiment that are illustrated in FIGS. 2 to 4. In the figures:

FIG. 1 schematically shows a definition of differentiable levels that can be applied according to the prior art in the case of a battery system;

FIG. 2 schematically shows a three-dimensional illustration of an example arrangement incorporating teachings of the present disclosure with closed tubes;

FIG. 3 schematically shows a three-dimensional illustration of an example arrangement incorporating teachings of the present disclosure with open tubes;

FIG. 4 schematically shows a three-dimensional illustration of an example tube incorporating teachings of the present disclosure with inserted battery module; and

FIG. 5 schematically shows a side view of the accommodating of a rack incorporating teachings of the present disclosure in an engine compartment with a battery module to be inserted from an engine aisle.

### DETAILED DESCRIPTION

In some embodiments of the teachings herein, a battery system racks for accommodating at least one first and at least one adjacent second battery module in a vehicle in order to form a battery system, e.g., in an engine compartment of the vehicle, in particular of a rail vehicle, includes:
a) the first battery module and second battery module are formed from a plurality of, in particular lithium ion, battery cells,
b) at least the first battery module is arranged in a separate tube, which is in particular formed rectangularly from four individual side parts,
c) the tube is formed from a fire-resistant material,
d) the tube has an opening, which is formed in a tube side and/or in one of the tube ends, in particular within a closure, for providing pressure relief,
e) the tube comprises a fire-resistant interface for the connection and operation of the battery module in the battery system,
f) the tube is designed such that, at every opening, a pressure relief means and a fire-resistant exhaust air device, in particular a chimney, is mounted such that gases emitted by the pressure relief means can be discharged in a controlled manner so as to be conveyed through the exhaust air device,
g) the tube, the interface and/or the pressure relief means is designed and/or arranged in such a manner that the battery module is at least temporarily hermetically sealed by the tube, the interface and/or the pressure relief means,
h) two sheet metal frames are designed such that, at front and back ends, in order to accommodate the tubes, they have cutouts formed according to the tube cross section, the edges of which cutouts are connected to the tubes R_{1 . . . n}.
i) the sheet metal frames for accommodating the battery modules are designed in such a manner that, between a tube of a battery module and adjoining surfaces, which are in particular connected to the adjacent battery modules by heat transfer, a multiplicity of air gaps are formed in such a manner, and are connected and designed in such a manner, that they form a structure which dissipates heat emitted by the respective battery module in a controlled manner by a chimney effect, wherein the cutouts and openings are arranged in such a manner that the exhaust air device, in particular between two tubes, is connected to said tubes,
j) the sheet metal frames for mounting the battery system are designed to be connectable at least temporarily to a base frame,
k) a first closure is mounted at the front end of each of the tubes and a second closure is mounted at the back end of each of the tubes so as to be tight with respect to gases produced inside the tubes, and
l) at least the tube is connected to the sheet metal frames and/or the exhaust air device so as to be in contact with them at least partly at welded joints.

The battery system racks described herein both provide protection against fire and its effects for the battery system containing the rack and formed therewith and for persons located in the vehicle or, under certain circumstances, also in the immediate vicinity of the vehicle. Any fire caused by a battery cell is restricted by the tube to the battery module containing this cell by the fire-resistant, that is to say at least high-temperature-resistant, material.

By suitably dimensioning and configuring this system, for example using redundancies, it is therefore additionally even possible to not adversely affect, or only insignificantly adversely affect the function of the battery system for the vehicle. Even elimination of the damage, that is to say essentially exchanging the battery module affected, is facilitated, since the battery module can be exchanged after removal of a closure and possible remediation work in the interior, and provides protection for the maintenance worker, since these effects according to the invention are provided in any operating state of the battery system or of the vehicle.

This protective function is provided, among other things, by the thermal insulation/partitioning of the battery modules from one another but also by the configuration of the elements of the battery system rack, that is to say the tubes welded to the rack and/or the exhaust air device. The matching configuration of these elements ensures that heat in the system is discharged quickly.

This may be advantageous both in normal operation and of advantage in the event of a fire, since desired temperatures during normal operation can be maintained, and this can, among other things, also reduce abnormal cell states, and the harmful influence on other battery modules in the event of a fire is prevented.

This may be enhanced further by the thermal insulation inside the tubes. This provides a further degree of freedom in setting the amount of heat energy or thermal power/heat flow passing into the enclosed module. Another degree of freedom can be provided by the selection of the properties of the tubes in such a manner that the housing is permeable to heat only in one direction, or is more permeable to heat in this direction, specifically outward. In such a configuration, the tube interacts with the thermal insulation in such a manner that the thermal insulation results in a metered discharge of heat and the temperature of the tube on its outer side is thus kept at a low temperature level. The heat energy is discharged in a metered manner over the outer surfaces of the casing for a prolonged period of time and thus represents the cooling of the system without excessively thermally loading the neighboring modules. At the same time, the insulation of the neighboring modules also brings about the thermal partitioning thereof. The insulating material thereof is affected at a low temperature level compared to that of a TRA event. The average value of a cold insulating material is generally significantly better than that of a hot insulating material, and therefore the insulating effect on the neighboring modules, which minimizes the heat flow, is higher than the insulating effect on a module affected by a TRA event (aim: reduced heat flow).

In the event of a fire, the function of the pressure relief means also has an effect, since in the case of a fire it is necessary to allow for an increase in pressure inside the housing, which has an effect on the structural stability of the housing and can destroy it. Suitable dimensioning of the pressure relief means ensures that on or before reaching a destructive pressure, the gas responsible for the pressure can escape.

In conjunction with the exhaust air device, a controlled, freely convective escape of the gas is ensured in such a manner that other elements of the battery system are not destructively affected either and the exhaust gases can be dissipated in a controlled manner into the open air. The mounting of the exhaust air device at the openings ensures in this case that the exhaust air device and the other rack elements at least partially withstand the function without damage and thus at least parts of the arrangement are available even after such an incident.

In some embodiments, the exhaust air device and in particular all of the other elements which are connected or can be connected outside the tubes are also additionally designed to be fire-resistant. Battery modules can in principle be formed by all types of battery cells in the case of which a fire or other destructive events that are transferred to neighboring modules cannot be completely ruled out.

If the battery system becomes homogeneous, that is to say completely fitted with such battery modules, all the battery modules can be accommodated, encapsulated in a tube incorporating teachings of the present disclosure, in the rack for forming the battery system rack. For this purpose, the respective module is pushed into the tube which is welded to the rack.

If it is a heterogeneous system, which also contains battery modules in which a destructive event of the properties mentioned can be ruled out or the probability thereof for a destructive event or destructive energy are so low that additional protection can be dispensed with, it is also conceivable that only the unsafe battery modules, i.e. those whose probability for destructive energy, in particular fire, is greater, are introduced exchangeably, encapsulated in a tube, in the rack.

The best protection may be achieved here if all of the battery modules are placed in a tube incorporating teachings of the present disclosure and connected to the rack, in particular at least partially based on welding. Therefore, the tube is, for example, welded or optionally joined to the sheet metal frame by means of flanges welded to the tube, for example by welding, riveting, screwing, clamping, adhesive bonding and/or similar connections.

The teachings herein thus make it possible to use at least partially unsafe battery modules, which are for example at least to some extent formed by lithium ion cells, and to integrate them in a battery system of a vehicle. This makes it possible to use battery cells which are more cost-effective and/or have a higher energy density.

As another example, some embodiments of the teachings herein include a method for accommodating at least one first and at least one adjacent second battery module in a vehicle in order to form a battery system, e.g., in an engine compartment of the vehicle, in particular of a rail vehicle, wherein:
a) the first battery module and second battery module are formed from a plurality of, in particular lithium ion, battery cells, and operated,
b) at least the first battery module is arranged in a separate tube, which is in particular formed rectangularly from four individual side parts, and operated,
c) the tube is formed from a fire-resistant material, and operated,
d) the tube comprises an opening, which is formed in a tube side and/or in one of the tube ends, in particular within a closure, for providing pressure relief,
e) the tube comprises a fire-resistant interface for the connection and operation of the battery module in the battery system,
f) the tube is designed and operated such that, at every opening, a pressure relief means and a fire-resistant exhaust air device, in particular a chimney, is mounted such that gases emitted by the pressure relief means can be discharged in a controlled manner so as to be conveyed through the exhaust air chimney,
g) the tube, the interface and/or the pressure relief means is designed and/or arranged and operated in such a manner that the battery module is at least temporarily hermetically sealed by the tube, the interface and/or the pressure relief means, h) two sheet metal frames are designed and operated such that, at front and back ends, to accommodate the tubes, they have cutouts formed according to the tube cross section, the edges of which cutouts are connected to the tubes,
i) the sheet metal frames for accommodating the battery modules are designed and operated in such a manner that, between a tube of a battery module and adjoining surfaces, which are in particular connected to adjacent battery modules by heat transfer, a multiplicity of air gaps are formed in such a manner, and are connected and designed and operated in such a manner, that they form a structure which dissipates heat emitted by a respective battery module in a controlled manner by a chimney effect, wherein the cutouts and openings are arranged and operated in such a manner that the exhaust air device, in particular between two tubes, is operated connected to said tubes,
j) the sheet metal frames for mounting the battery system are designed to be connectable at least temporarily to a base frame, and operated,
k) a first closure is mounted at the front end of each of the tubes and a second closure is mounted at the back end of each of the tubes so as to be tightly operated with respect to gases produced inside the tubes, and
l) at least the tube is connected to the sheet metal frames and/or the exhaust air device at least partially based on welding.

In some embodiments, at least one reinforcement rib which at least partially surrounds the cross section of the tube is welded onto the tube. The tube structure is thus stabilized and especially the resistance to pressure from the interior increased.

In some embodiments, the tube is formed from stainless steel and is operated in this way. Thus a tube is provided which provides a very good combination of fire resistance, stability and thermal conductivity.

In some embodiments, the battery system rack can be configured and operated such that the thermal insulation is formed from a bidirectionally insulating material. This makes it possible to meter the discharge of heat in both directions. As a result, additional degrees of freedom in the optimization of the protection are provided.

In some embodiments, the battery system rack can also be operated in such a manner that the pressure relief means is in the form of a rupture membrane connected to the tube and/or to the thermal insulation, and operated. This gives a simple and cost-effective implementation of the pressure relief means, which ruptures in the direction of the exhaust air device above a determined pressure owing to exhaust combustion gases and/or after a determined temperature is reached and can thus allow the discharge of exhaust gases and/or heat. This membrane can then be part of the tube and/or of the thermal insulation.

In some embodiments, the pressure relief means is in the form of a rupture disk connected to the tube and/or to the thermal insulation. Such rupture disks are standardized and generally contain a rupture membrane with the aforementioned advantages, such that an accommodation option, in accordance with the standard, can be provided in the housing or in the thermal insulation. Such standardized parts are generally obtained in relatively large numbers and therefore, in addition n to the aforementioned advantages, have the advantage that they are more cost-effective to acquire.

In some embodiments, the pressure relief means is, and is operated, in the form of at least one spring-loaded pressure relief flap connected to the tube, tube cover and/or the thermal insulation. A spring-loaded pressure flap has the advantage that it only allows solids smaller than the diameter of the flap opening through. By contrast to the rupture membrane or the rupture disk, therefore, only the very smallest solid particles, which are generally easier to remove, enter the exhaust air device. The pressure relief flap itself is also not subject to destruction and closes again after the excess pressure has been discharged, with the result that the oxygen supply into the interior of the module is then interrupted. This thus additionally increases the fire protection.

In some embodiments, the housing, in particular as many of the elements of the battery system rack as possible, is formed from stainless steel. Elements involved with the rack are provided which provides a very good combination of fire resistance, stability and thermal conductivity. Moreover, stainless steel does not need a rust-resistant coating and lacquering, which are often necessary in the case of other materials. These are potentially combustible. This configuration therefore also reduces the fire loading.

In some embodiments, in order to seal the first and/or second closure, a sealing surface is in each case provided between the closures and tubes. For elements of the tube which are not welded, this ensures that they permit an at least virtually hermetic sealing of the interior or protection of the tube exterior. For example, a closure, in particular the second closure, can be configured in such a manner that it can be opened in order, for example, to exchange a module, or it can be configured to be permanently closed, i.e. designed, for example, as a cover which is welded in place.

In some embodiments, the second closures are each welded to the back side of the tubes and/or to the edges of the cutouts of the sheet metal frame. The greater the number of connections which are produced by welding, the more stable and secure is the construction. Furthermore, this may protect the other modules, by the interior of a module having a TRA event being hermetically insulated as far as possible from the exterior.

In the views of the examples, the described components of the embodiment each constitute individual features of the teachings herein that are to be regarded independently of one another and each also refine the teachings independently of one another, and thus also can be considered to be a constituent part on their own or in a different combination to that shown. Furthermore, the described components of the embodiments illustrated can also be supplemented by other already-described features. Any statements regarding functions and mode of operation can moreover be regarded as an exemplary embodiment of procedures.

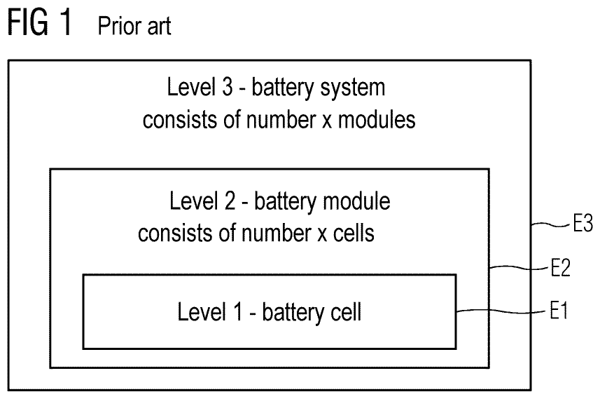

Identical reference signs have the same meaning in the various figures. FIG. 1 illustrates, as described at the beginning, the subdivision of a typical lithium-ion battery system for traction-related and electrical system applications. This subdivision serves as a basis for the determination of functional units. They are placed in a relationship, among other things, for the definition of safety requirements according to the EN 62619 standard.

What is shown is the first level E1, which denotes a first functional unit formed by a battery cell. What is also shown is the second level E2, which denotes a second functional unit that is formed by a battery module and is generally formed from a plurality of cells, that is to say first functional units. What is lastly shown is also the third level E3, which denotes the third functional unit that is formed by a battery system and is formed from at least one battery module. The safety requirement according to the EN 62619 standard, what is referred to as the thermal propagation test (TPT), is met when it can be proved that the system is configured such that, in the event of a TRA, fires either at cell level E1, module level E2 or at battery system level E3 can be ruled out.

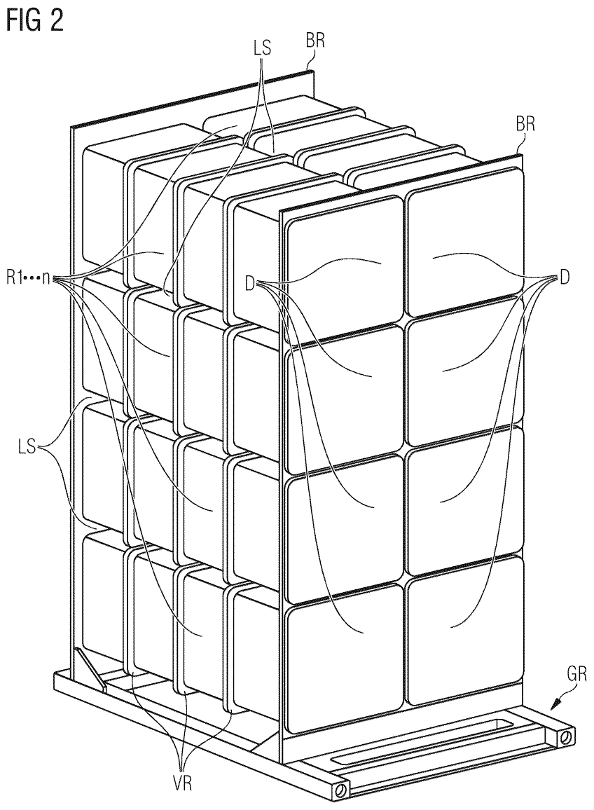

To this end, the teachings of the present disclosure include implementing the TRA protection at module level E2, which leads to fire protection of level E3 and thus realizes the second alternative according to the standard, wherein the views of an exemplary embodiment that are shown in FIG. 2 to FIG. 5 show a construction which may be distinguished by particularly easy implementation.

FIG. 2 shows a rack structure in a three-dimensional illustration as an exemplary embodiment of an arrangement incorporating teachings of the present disclosure. It can be seen that the rack has a basic frame GR. Sheet metal frame parts BR1 . . . B2 cut out are fastened thereon. A releasable connection, for example a screw/rivet connection, and/or a non-releasable connection, for example welding, can be used for the fastening.

The basic frame GR is also configured in particular in such a manner that the construction can be fastened, preferably releasably, therewith in an engine compartment of a train. As can be seen in the case of the front sheet metal frame part BR1, i.e. the sheet metal frame part arranged at the front end of the rack, the sheet metal frame part BR1 has rectangular cutouts. The same also applies to the rear sheet metal frame part B2 which is not completely visible and is located at the back end of the rack. It can furthermore be seen that, according to the example, n=8 rectangularly shaped tubes R_{1 . . . n} are fastened between the cut-out sheet metal frame parts BR1 . . . BR2.

The tubes R_{1 . . . n} have here a rectangular cross section, which is dimensioned corresponding to a cutout A_{1 . . . 2n} in such a manner that the tubes R_{1 . . . n} are fastened by welding to those parts of the sheet metal frame B1 . . . . B2 which comprise the rectangular cutout A_{1 . . . 2n} of the respective sheet metal frame B1 . . . . B2. A tube R_{1 . . . n} is attached by the welding at its front end and its back end to two opposite cutouts A_{1 . . . 2n}. The tube R_{1 . . . n} is in each case formed here in such a manner that the side walls of the tube Rim are in each case welded to each other, and therefore there is in each case a hermetic closure thereon by in each case two edges forming welded side parts.

Furthermore, the back end of the respective tube R_{1 . . . n} can also be closed in such a manner that a cover is welded thereon, and therefore a hermetic closure is also formed here.

The tubes R_{1 . . . n} serve for accommodating battery modules (not illustrated). So that a battery module can be inserted and also removed again at any time, the front end of the tubes R_{1 . . . n} is not welded, but rather a further cover is brought releasably onto the front end, for example after a battery module is accommodated. Should it be required to configure the closure (cover) D on the back end also to be releasable, in order, for example, to be able to carry out maintenance/removal, said closure can likewise be attached releasably.

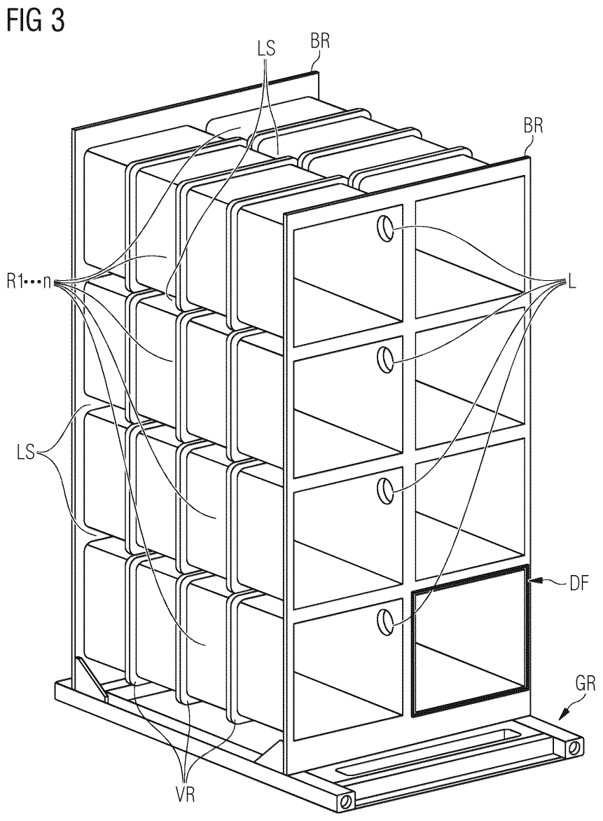

The tube R_{1 . . . n}, the cover D and/or the cut-out sheet metal frame BR1 . . . BR2 are configured here in such a manner and coordinated with one another with regard to the dimensioning in such a manner, that the releasable closure remains in its position tightly and stably against a pressure produced in the interior and as far as possible no gases can escape. For this purpose, sealing surfaces DF, of which one is shown by way of example in FIG. 3, between cover D and the respective tube R_{1 . . . n}, on which the cover D is attached, for example by clamping, can alternatively or in addition also make a contribution to the tightness.

As can be seen in FIG. 2, the tubes R_{1 . . . n} are also reinforced in such a manner that reinforcement ribs VR are provided to increase the stability of the welded side parts. For this purpose, said reinforcement ribs can be threaded onto the tubes and then likewise connected to the side parts by welding. The material from which the side parts and the covers D are formed may comprise stainless steel. This has the advantage that it has very good values with regard to heat conductivity, stability and fire resistance and is an ideal combination. Furthermore, because a surface treatment, for example by means of lacquer, is unnecessary, it also has a lower fire loading, if any at all, which could impair these ideal properties.

It can be seen in FIG. 2 that air gaps LS are formed between side parts of the individual opposite tubes R_{1 . . . n} after the fastening between the sheet metal frames B1 . . . . B2. This can be achieved in that the dimensioning of the sheet metal frames BR1 . . . BR2, the tubes R_{1 . . . n} and/or cover D is correspondingly configured to the effect that the side parts of the tubes R_{1 . . . n} come to lie at a desired distance and thus form an air gap LS. These air gaps LS serve for cooling the battery system rack according to the invention since heat produced in the event of a fire is dispensed via the side walls into the air in the air gaps LS and therefore a chimney effect can be realized which quickly guides the heated air out of the rack.

A three-dimensional illustration of the rack can also be seen in FIG. 3, but without front-end covers D, and therefore part of the interior of the tubes R_{1 . . . n} according to the exemplary embodiment can be seen. It can be seen here that, in the front part of a tube R_{1 . . . n}, a circular cutout L is arranged on that side wall which is perpendicular to the basic frame GR and, with an opposite, vertical side wall of a further tube R_{1 . . . n}, forms an air slot LS, which is arranged perpendicularly to the basic frame GR.

In said cutout, it is possible to accommodate, in a manner filling said cutout L, a pressure relief device, for example a rupture disk (not illustrated), a rupture membrane (not illustrated) fastened directly in the cutout, or a spring-loaded pressure flap (not illustrated) which, in the event of a formation of gas caused, for example, by a fire lets out a pressure or the formed gas in a controlled manner outward with respect to the tube R_{1 . . . n} if said pressure or gas reaches a predefined value which could put stability of the tubes R_{1 . . . n} at risk.

In order not to put adjacent tubes R_{1 . . . n} at risk, an exhaust gas chimney AK is therefore introduced into the air slot LS at this point, which exhaust gas chimney at all of the cutouts L configured in such a manner is connected tightly to said cutouts L and to the pressure relief means in such a manner that it can remove the gas without the latter escaping in some other way. This allows, in the event of a TRA, the damage to the affected battery module is limited. However, the exhaust gas chimney AK and cutout L for the pressure relief means are not restricted to the described embodiments. The exhaust gas chimney may also be placed at a front end or back end as can the cutouts L.

FIG. 3 furthermore schematically shows the sealing surface DF already discussed above, as can be provided between each cover D and tube R_{1 . . . n}. Fastening elements or counter parts for a fastening, as can be provided for the releasable fastening of the modules BM, can also be seen at the base of the tubes R_{1 . . . n}.

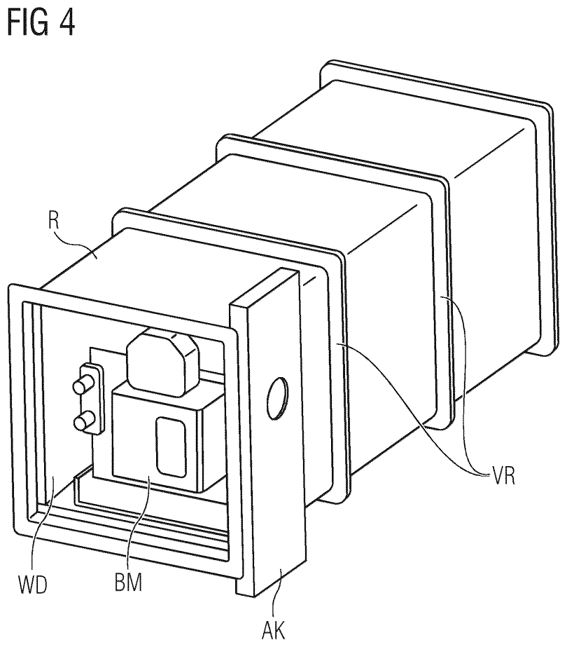

As can be seen in FIG. 4, the exhaust gas chimney AK has a narrow shape in comparison to the length of the tubes R_{1 . . . n} in such a manner that the vertically formed air slots LS can provide the described chimney effect for conducting away heat energy dispensed to the tubes R_{1 . . . n} by heat transfer. Furthermore, a battery module BM introduced into the tube R_{1 . . . n} is seen in FIG. 4 and it can be seen that said battery module can be fastened to the base of the tube R_{1 . . . n}, for example via a frame.

Thermal insulation WD is provided between the battery module and walls of the tube R_{1 . . . n} containing it. The thermal insulation WD may be provided bidirectionally such that the heat energy which passes to the thermal insulation from the outside via the side walls of the tube R_{1 . . . n} for example caused by a fire in an adjacent tube R_{1 . . . n}, is dispensed inward only in metered fashion. Conversely, heat energy forming in the interior is dispensed to the outside only in metered fashion.

This aim is also contributed to, inter alia, by the air slots LS and the tubes R_{1 . . . n} and the bidirectional thermal insulations. The tubes R_{1 . . . n} are stable but also have very good heat conductivities and the thermal insulation WD since they protect the respective battery module BM against heat penetrating from the outside and also restrict an output of heat in the event of a TRA to such an extent that this suffices solely and/or in interaction with the other features according to the invention of the arrangement or the method in order not to disturb the functionality of the safe battery modules.

The thermal insulation WD and/or the tube R is configured here in such a manner that it virtually completely surrounds the battery module after the latter has been inserted. In addition to the cutout with the pressure relief means L, the tube and/or the thermal insulation has further cutouts only for required connections. For example for the connection of an interface to the battery module so that the latter can be connected in turn to the battery system. The interface (not illustrated) may also be configured here in such a manner that it does not let out the pressure from gas in the interior and is fire-resistant.

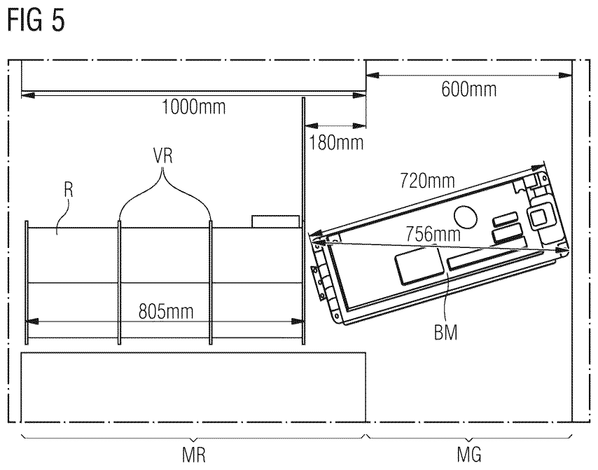

FIG. 5 schematically shows how a battery system rack incorporating teachings of the present disclosure may be accommodated in an engine compartment MR. The latter has a cross section of 1000 mm, into which the battery system rack is introduced. The engine compartment is therefore generally greatly limited spatially and can be reached only via a likewise narrow engine compartment aisle MG, of 600 mm in the example, for required manipulations.

Owing to the tubes R which are welded to the rack and are fastened in the engine compartment MR via a frame, after the closure on the front end of the tube R is removed, a battery module BM can be introduced. Owing to the fact that the pure battery module, i.e. a battery module essentially not loaded with elements not belonging to the module, is inserted, the battery module BM in the illustrated example has a length of 720 mm and a diagonal of 756 mm. It would therefore be longer than the width of the engine compartment aisle MG. Nevertheless, it can be introduced.

For this purpose, the illustrated battery system rack has a depth of 805 mm, i.e. is 180 mm shorter than the engine compartment MR in cross section, and therefore the battery module can be inserted diagonally in a type of “sliding and digging” movement. That is to say, introduced diagonally at the beginning until a horizontal continuation of the movement of the battery module BM into the tube R is possible.

The teachings of the present disclosure may allow use of “unsafe” cells. This makes it possible to use lithium cells with a very high energy density in vehicles, in particular rail vehicles. The error susceptibility of the construction against extreme temperatures is further reduced by the small number of sealing surfaces. The exhaust gas chimney AK for each module BM is guided and connected centrally between the tubes R_{1 . . . n} in order to make use of as much construction depth as possible with the tube R, R_{1 . . . n} itself.

The TRA is limited to a battery module affected by TRA, i.e. a generally unsafe battery module. Accordingly, the teachings herein to some extent defines the smallest combustible unit which fails in a battery module in the interior of its tube R_{1 . . . n}. The concept may be especially useful for lithium-ion cells, which have no protection mechanisms at cell level. However, it is not restricted thereto. Fundamentally, the teachings provide a potential reduction in damage caused by destructive energies from a fire in any kind of module. However, it is its protective concept that affords the most advantages specifically if unsafe cells are being used.

It becomes possible that only the module affected needs to be changed after a fire event. Depending on the control and interconnection of the modules, or in a manner assisted by redundancies, in such a case the operation of the battery system BS can be continued virtually uninterrupted.

The construct is configured here in such a manner that it can also be accommodated in in an engine compartment of a rail vehicle and, despite the confined conditions, a battery module can be exchanged there by the rack being arranged in such a manner that the front-end cover D is released and the old battery module removed in the direction of the engine compartment aisle and replaced by a new one. If this aisle is very narrow, the rack, the battery modules to be used and/or the tubes R_{1 . . . n} can be dimensioned in such a manner that a battery module can be inserted or removed obliquely. For this purpose, for example, the height of the tubes R_{1 . . . n} could be positioned higher in order to permit a larger angle in the guiding of the battery module into or out of the tube R_{1 . . . n}.

Since the various embodiments make active extinguishing obsolete and the intended cooling method and the developments are a purely passive solution, the protection in all operating states is provided, in particular even when the vehicle is shut down.

The teachings may allow for protection according to TPT, to disengage from a safety mechanism at cell level that is necessary in the first level E1. It is possible to use substantially more favorable lithium-ion cells. These are available in considerably greater numbers than safer lithium-ion cells and thus reduce the cell costs of the battery system BS. The solution also requires substantially no concept realized in the third level E3, which is also implementable only with great difficulty, since the TRA energy being released from the overall burning battery system with a high number of cells makes any protective measures technically unimplementable and uneconomical.

The teachings may thus overcome the disadvantage that the container that provides resistance at the onset of a TRA is for the entire battery system BS. In that case, there is namely loss of the overall system solely due to a TRA in one cell. A saving is also made on a heavy outer housing which needs to be dimensioned for large amounts of energy, this driving up costs. The teachings thus additionally reduces likelihood of any outages. There is even a design buffer for future cell generations that have an even higher energy density. More than enough protection is therefore provided for current systems.

The outlay necessary for this is run out in an acceptable use of additional material and/or extra weight for the TRA protection, since the tubes R_{1 . . . n} also at the same time form parts of the entire rack. The significant reduction in weight in comparison to constructions which have substantially releasable connections. By this means, a high degree of automation of the manufacturing is also possible. Furthermore, the welding affords that a high gas density is obtained by joining multiple individual parts. By this means, the number of sealing surfaces required is low.

The teachings may also enable the battery modules in conventional engine compartments, for example of trains, to be exchangeable.

The teachings are not restricted to the exemplary embodiments shown and discussed of the arrangement and of the method and their developments. Rather, the teachings as defined by the claims is intended to include all the variants—even those that are not claimed—that are covered by the claims.

What is claimed is:

1. A battery system for a vehicle the system comprising:
a first battery module and a second battery module each formed from a respective plurality of battery cells;
wherein the first battery module is arranged in a separate tube including four individual side parts of a fire-resistant material;
the tube has an opening formed in one of the four side parts to provide pressure relief;
the tube comprises a fire-resistant interface for the connection and operation of the first battery module;
a pressure relief device and a fire-resistant exhaust air device arranged at the opening mounted so gases emitted by the pressure relief means can be discharged in a controlled manner and conveyed through the exhaust air device;
wherein the tube, the interface, and/or the pressure relief means provide at least a temporary hermetic seal for the first battery module;
two sheet metal frames with cutouts disposed at respective front and back ends to accommodate the tube, wherein the edges of the cutouts are connected to the tubes;
wherein between the tube and an adjoining surfaces thermally connected to the second battery modules, a multiplicity of air gaps are connected to form a chimney dissipating heat emitted by the battery module, wherein the exhaust air device is connected to the tube;
wherein the two sheet metal frames are connectable at least temporarily to a base frame;
a first closure mounted at the front end of the tube; and
a second closure is mounted at the back end the tube so as to make the tube gas-tight;
wherein the tube is connected to the two sheet metal frames and/or the exhaust air device by welding.

2. The battery system as claimed in claim 1, further comprising a reinforcement rib welded to the tube and at least partially surrounding the cross section of the tube.

3. The battery system as claimed in claim 1, wherein the thermal insulation comprises a bidirectionally insulating material.

4. The battery system as claimed in claim 1, wherein the pressure relief comprises a rupture membrane connected in the opening of the tube, the exhaust air device, and/or the thermal insulation.

5. The battery system as claimed in claim 1, wherein the pressure relief means comprises a rupture disk.

6. The battery system as claimed in claim 1, wherein the pressure relief means comprises a spring-loaded pressure relief flap.

7. The battery system as claimed in claim 1, wherein the tube, the two metal sheets, and/or the exhaust air device comprise stainless steel.

8. The battery system as claimed in claim 1, further comprising a sealing surface to seal the first and/or second closure provided between the closures and the tube.

9. The battery system as claimed in claim 1, wherein the second closure welded to the back side of the tube and/or to edges of the cutouts of the sheet metal frame.

10. A method for mounting a first battery module and second battery module in a vehicle in order to form a battery system, the method comprising:
forming the first battery module and second battery module from a respective plurality off battery cells;
arranging the first battery module in a separate tube formed rectangularly from four individual side parts;
wherein the tube comprises a fire-resistant material;
wherein the tube comprises an opening formed in a tube side, for providing pressure relief;
wherein the tube comprises a fire-resistant interface for the connection and operation of the battery module;
wherein, at every opening of the tube, a pressure relief means and a fire-resistant exhaust air device is mounted such that gases emitted by the pressure relief means can be conveyed through the exhaust air device;
wherein the tube, the interface, and/or the pressure relief means provide at least temporarily hermetically sealing;
wherein two sheet metal frames-, at front and back ends, have cutouts formed according to a cross section of the tube, the edges of which cutouts are connected to the tube;
wherein between a tune and an adjoining surface thermally connected to the second battery module, a multiplicity of air gaps form a dissipating heat emitted by the battery module in a controlled manner;
wherein the cutouts and openings are arranged so the exhaust air device is connected to tube;
wherein the sheet metal frames are connectable at least temporarily to a base frame;
wherein a first closure is mounted at the front end of the tube and a second closure is mounted at the back end of the tube to create a gas-tight seal with respect to gases produced inside the tube;
wherein the tube is connected to the sheet metal frame and/or the exhaust air device by welding.
